(19) United States
(12) Patent Application Publication
(10) Pub. No.: US 2012/0267898 A1
(43) Pub. Date: Oct. 25, 2012

(54) INTEGRATED RANKINE-CYCLE MACHINE

(75) Inventors: Paolo Mazza, Guastalla (IT); Gino Zampieri, Guastalla (IT)

(73) Assignee: NEWCOMEN S.R.L., GUASTALLA (REGGIO EMILIA) (IT)

(21) Appl. No.: 13/384,082

(22) PCT Filed: Feb. 11, 2010
(86) PCT No.: PCT/EP10/51725

§ 371 Date: Jan. 13, 2012

(51) Int. Cl. H02K 7/18

(52) U.S. Cl. 290/1 A

(57) ABSTRACT

Machine operating on the Rankine cycle for converting thermal energy into electric energy by making use of low-temperature heat sources for the production of electric energy, comprising a cylinder and a related piston, which a related main shaft is associated to, a direct-voltage power generator, which comprises a rotor and a respective stator and is driven by said main shaft, wherein said cylinder is fed at the head portion thereof through two ports ensuring inlet and exhaust, respectively, by means of a rotating valve provided with at least a through-aperture, which is adapted to enable a flow passage to be established between an inlet conduit and the inner chamber of said cylinder; said rotating valve is driven by a plurality of motion transmission members connected to the main shaft, the latter being in turn connected to the rotor of a power generator. Preferably, said cylinder, said main shaft, said motion transmission members, said power generator and said rotating valve are entirely contained within a sealed casing, the wall of which is provided with a passageway for the electric connections, as well as an inlet mouth and an outlet mouth for the gas used as the working fluid for the Rankine cycle.

The present invention refers to an integrated, closed-cycle machine for the generation of an electric power source based on the recovery and the conversion of heat by means of a Rankine cycle.

In addition, said machine shall be provided so as to be able to operate in a fully autonomous manner for very long periods of time, shall not require any maintenance for a long time, and shall be inherently isolated from and protected against external agents or matters.

It is a commonly known fact that there is a large availability of various heat sources, in particular low-to-medium temperature ones, which are currently lost, and therefore wasted, into the environment since—given the recovery and conversion means and processes available for use nowadays—a conversion of such heat into electric energy would unavoidably turn out as excessively expensive with respect to the power produced and, as a result, such heat sources—even if they are finding some utilization, albeit to a rather limited extent, in professional applications—are scarcely used for more popular applications at a consumer level, such as in particular—but not solely—in households and the like.

The most common heat sources of the above-noted kind, to which reference is made herein in a preferential manner, are available both as a by-product of human activities and in nature.

Heat sources originating from a human activity include, for example, the heat contained in industrial waste or scrap products, and the heat contained in bio-masses if the latter are burnt.

Heat available in nature is mainly represented by the heat provided by solar radiations, which can in fact be captured, collected, converted and conveyed with the use of a variety of means as they are generally well-known in the art to such purposes.

Largely known in the art there is a number of applications of the Rankine cycle in view of both recovering the thermal energy existing in a body and subsequently using such heat to produce electric energy; in this connection, a preferred embodiment is based on the use—as an expansion chamber—of a turbine of a kind as generally known as such in the art.

This solution, however, has a number of definite constraints and drawbacks, which are largely known to all those skilled in the art and may be summarized as follows:
the rather high costs of the turbine and the related control elements,
a need for maintenance to be provided rather frequently, along with costs and charges of various kind and nature to be sustained in connection therewith, and
above all, a major limitation connected with the use of a turbine derives from the fact that the highest efficiency of the turbine is obtained at a definite flow-rate of the working fluid in the expansion phase, as well as at an equally definite speed of rotation, wherein the efficiency of the turbine is liable to decrease to quite dramatic an extent if such rotating speed varies even by quite slight an extent from said optimum value.

Such limitation can be most readily appreciated to be usually unacceptable when use is made of heat sources, the thermal output of which is widely variable, as this occurs in the afore-exemplified cases, actually.

In view of doing away with such kind of drawback, a largely known practice is based on the use—as an expansion chamber—of a common cylinder, within which there is provided a respective piston adapted to slide in a sealed manner therein, said piston being in turn connected to a related piston or connecting rod, from which the converted power is then taken for practical use with the aid of mechanical means.

This mode of embodying a Rankine cycle proves in particular advantageous if the machine that operatively performs the same Rankine cycle is associated to or integrated with another machine that uses the motive power being generated and output by said Rankine-cycle engine.

Known for instance from the U.S. Pat. No. 4,720,978 is the use of solar heat by means of a Rankine-cycle engine to provide a machine for pumping liquids, especially water or oil, in regions in which electric energy is not available, or wherever a continuous attendance of power generating stations is impracticable.

The liquid pumping machine described in the above publication proves particularly advantageous, since it uses—as the expansion chamber for the Rankine cycle—a cylinder provided with a double-acting piston, wherein the free end of the driving shaft of the same piston is applied to a second piston of a second cylinder that is connected thereto and operates as a pump.

Such solution is found to be particularly simple and advantageous, also due to the fact that it is based on a construction featuring a considerable extent of integration involving a number of basic functional members thereof; however, as hinted hereinbefore, it relies upon the so-called mechanical analogy for its operation, as well as a connection between two cylinders; furthermore, it cannot be used to any advantageous effect when a source of electric energy has to be provided, actually.

Known from the U.S. Pat. No. 5,088,284 is a method for providing a compressor obtained by integrating a Stirling engine with a machine that uses the Rankine cycle, which in turn operates by using the energy from a heat source of a generic nature and, preferably, the heat from solar radiations.

Even this solution may be considered as being a fully advantageous and practicable one; furthermore, it is sensibly compact in its construction. However, even in this case there is a practical drawback in that it is limited to the sole function or duty it is designed for, i.e. the operation of a gas compressor.

Disclosed in the U.S. Pat. No. 4,571,946 is an internal combustion engine provided with a rotating and driving shaft for the transmission of the force being produced, wherein the heat contained in the exhaust gases of the engine is recovered by a rotary element operating on a Rankine cycle; this rotary element is connected with and acts upon said main rotating and drive shaft so as to increase the torque thereof and, as a result, ultimately increase the energy efficiency of the entire engine.

Anyway, even such solution turns out as being optimized just in view of the particular use it is intended for, and it cannot be transferred to applications involving power generation in any simple and direct manner.

Again, from the disclosure in the U.S. Pat. No. 4,901,531 there is known an integrated Diesel-Rankine system, in which a Diesel engine is provided with a plurality of cylinders operating in a basically conventional manner.

At least one of these cylinders is not used for carrying out the Diesel cycle;

quite on the contrary, it is used as the expansion chamber of a fluid that is previously vaporized by making use of the heat recovered from the exhaust gases from the other cylinders that work according to the Diesel cycle.

This solution, which is explicitly suggested for use in particular when the Diesel engine is working under full load conditions, proves therefore most advantageous in view of increasing the efficiency of the entire engine. Anyway, even in this case the effect being provided by the arrangement is not particularly aimed at or particularly advantageous in connection with a power generation duty.

Known from the disclosures in JP 10252558, JP 10252557 and JP 10259966 there are various technical solutions and related arrangements, which use the Rankine cycle to a variety of different purposes, or various combinations of machine embodiments aimed at optimizing the Rankine cycle; however, none of these technical solutions and arrangements is found to be particularly advantageous for power generation duties, especially when the thermal energy used in the cycle is delivered and made available under widely varying conditions.

It would therefore be desirable, and it actually is a main object of the present invention, to provide a kind of Rankine-cycle machine, or engine, which uses a heat source of a general nature and featuring a wide variability of the heat output delivered to the cycle, and which performs as a power generating plant capable of ensuring a power supply source that is capable of operating for long periods of time without requiring any maintenance, while forming a highly integrated and compact unit.

According to the present invention, this and further aims are reached in a machine operating according to the Rankine cycle, as integrated with a power generator, which is embodied to incorporate and operate according to the characteristics and features as recited in the appended claims.

Anyway, features and advantages of the present invention will be more readily understood from the detailed description that is given below by way of non-limiting example with reference to the accompanying drawings, in which:

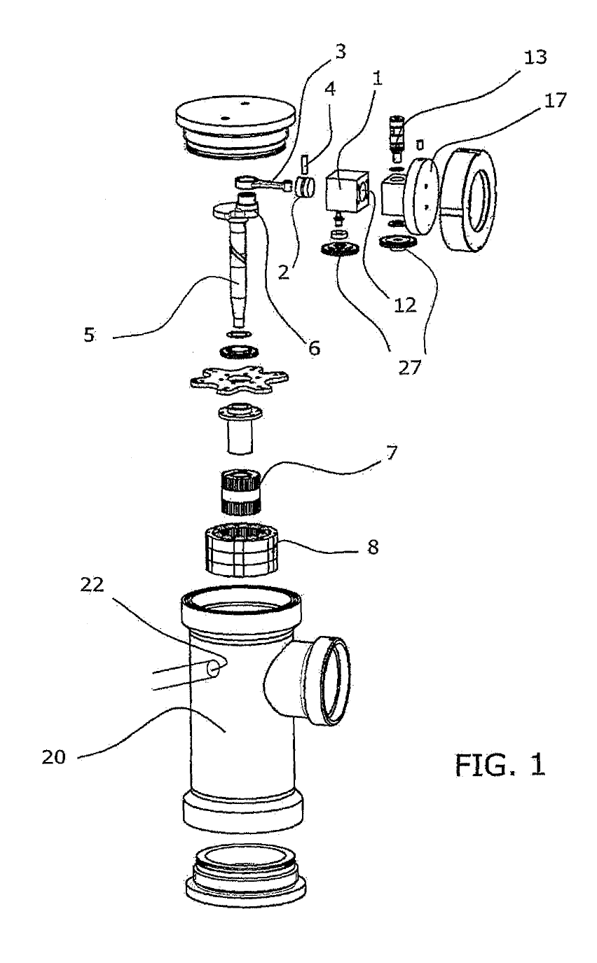

FIG. 1 is a perspective, exploded view of a part of a machine according to the present invention;

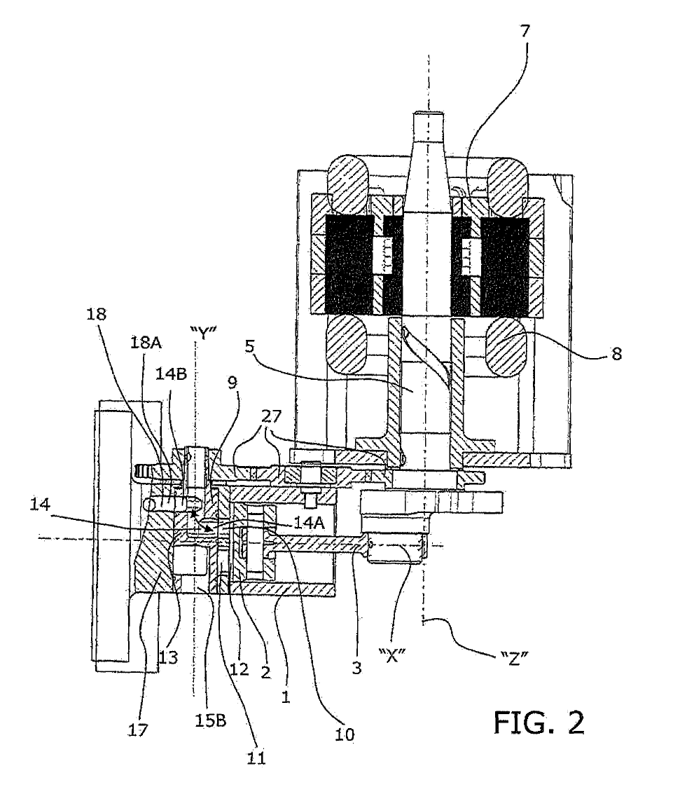

FIG. 2 is a median cross-sectional view along two main axes X and Z of the machine shown in FIG. 1, in a definite instant in the operation thereof, when the piston 2 has moved to a point close to the top dead centre;

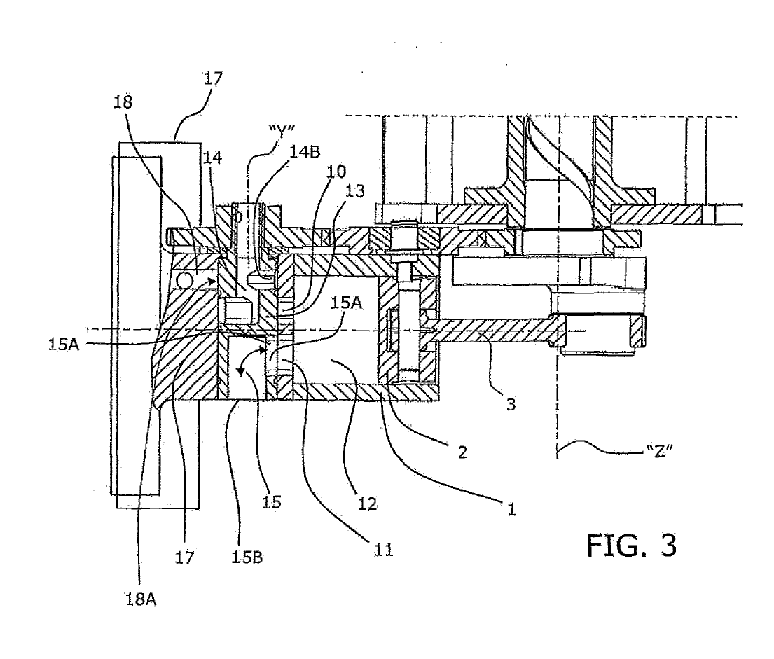

FIG. 3 is a second view similar to the one in FIG. 2, but with the same piston 2 lying close to the bottom dead centre in this case;

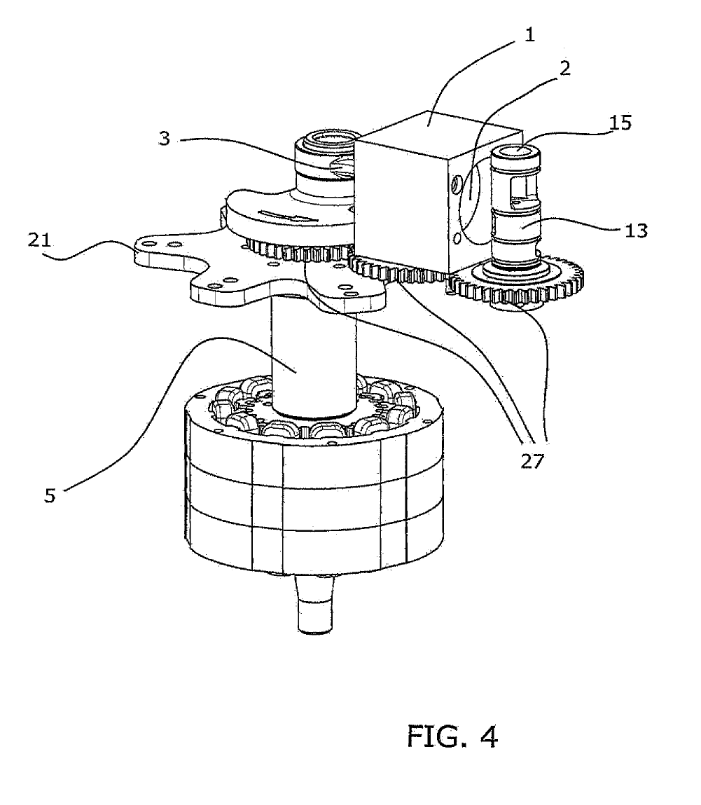

FIG. 4 is a perspective, partially cut-away view of a sub-assembly including some of the basic component parts of the machine according to the present invention, as viewed in the state shown in FIG. 2;

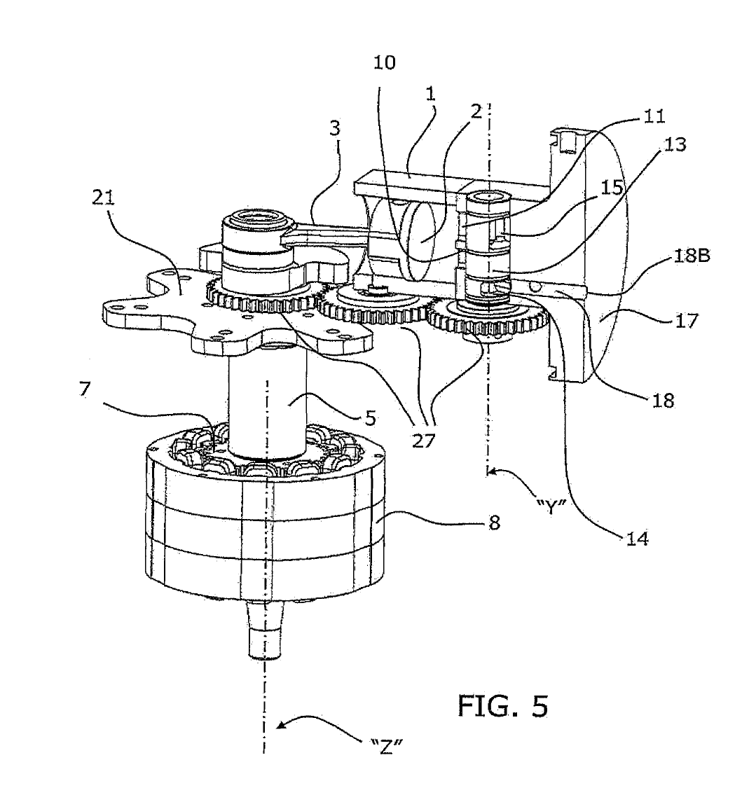

FIG. 5 is a perspective view similar to the view in FIG. 4, but relating to the state shown in FIG. 3, as well as with the addition of a further component part (i.e., the body 17);

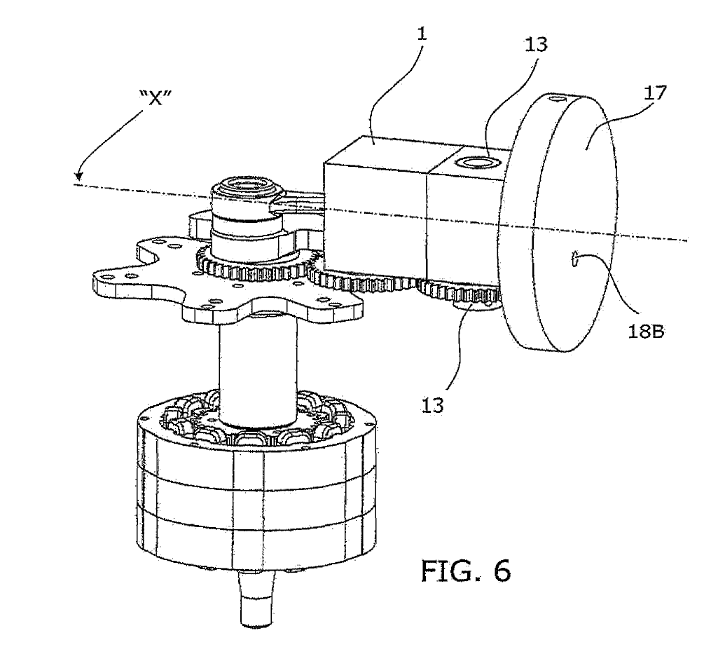

FIG. 6 is a similar view as the two preceding ones, wherein the component parts are however no longer viewed in a cut-away representation, but rather from outside;

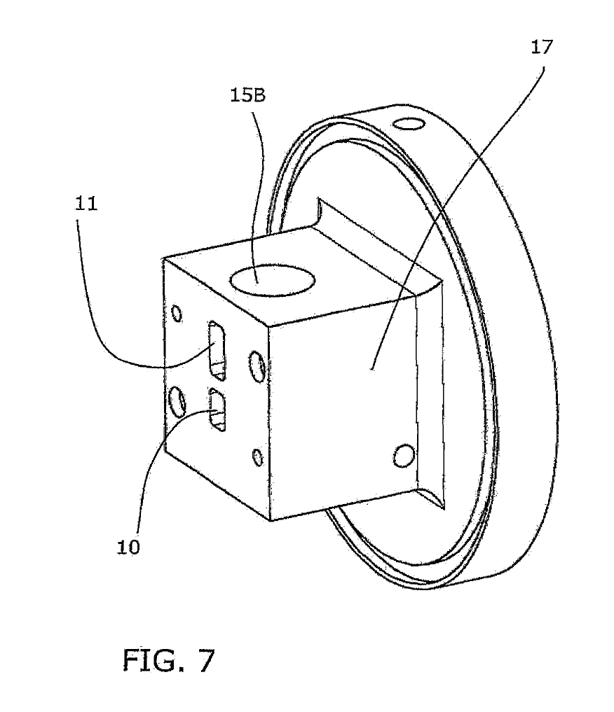

FIG. 7 is a perspective view of a specific component part included in the representation of FIG. 5;

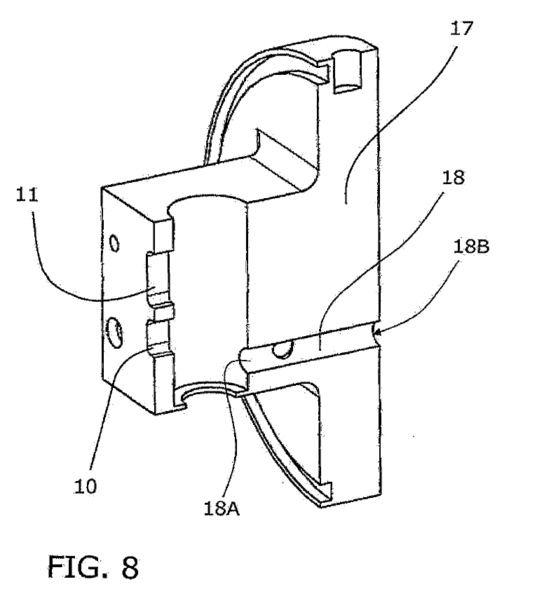

FIG. 8 is a perspective, median cross-sectional view of the component part shown in FIG. 7;

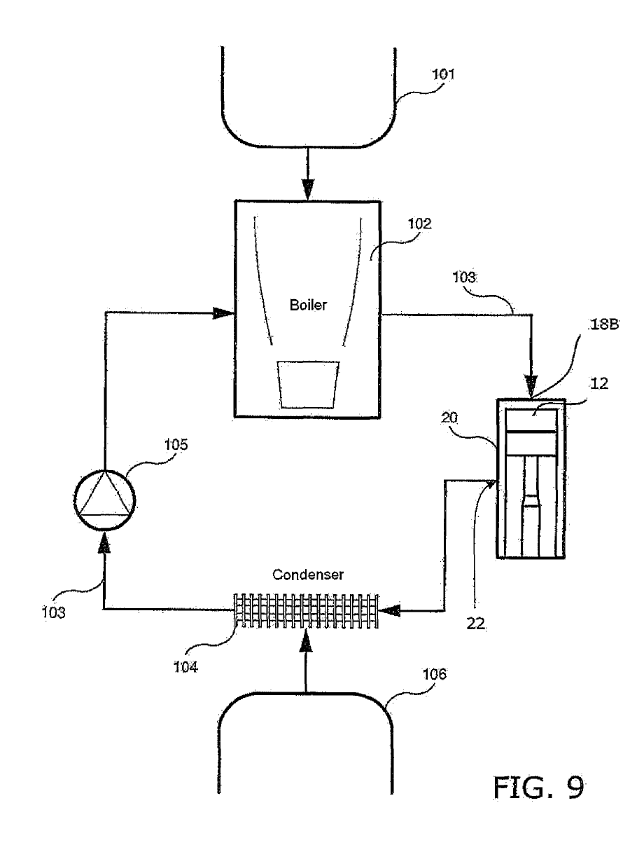

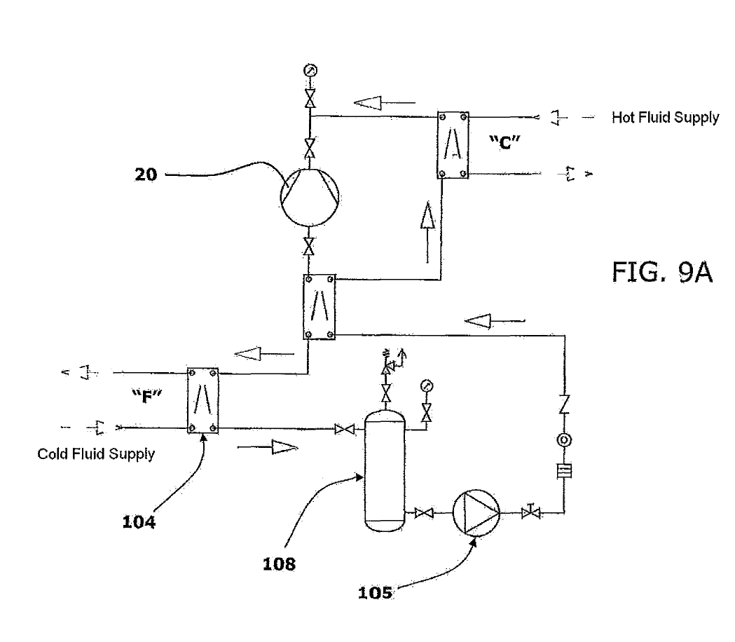

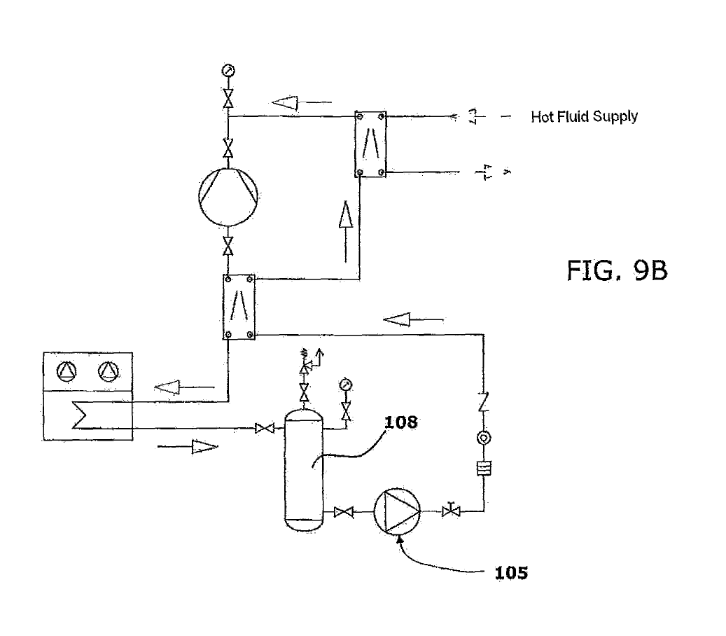

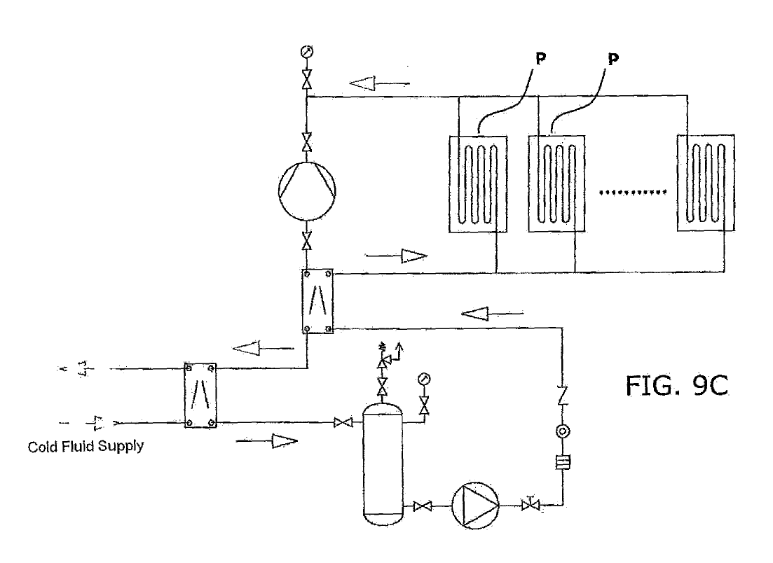

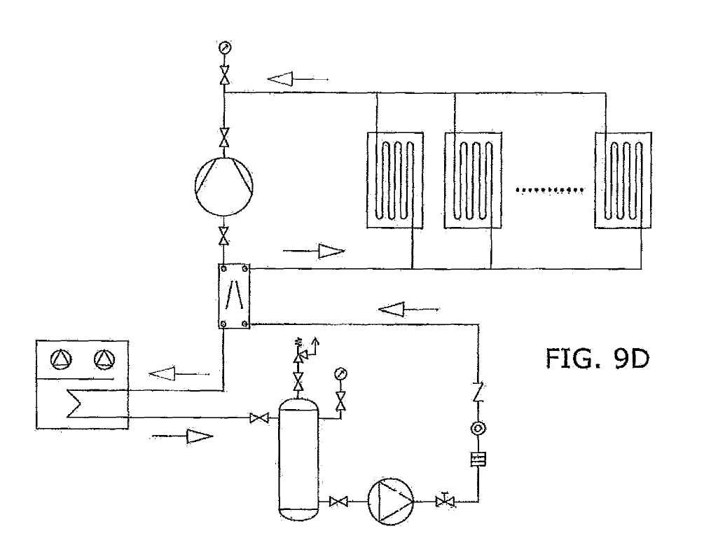

FIG. 9 is a schematic view of a basic connection diagram of an arrangement providing for a preferred utilization of the machine according to the present invention;

FIGS. 9A, 9B, 9C and 9D are schematic views of respective connection diagrams of the machine according to the present invention, as connected to different kinds of heat sources and different kinds of cooling sources, all of them represented in a symbolical manner.

With reference to FIGS. 1 through to 8, a machine operating on the Rankine cycle according to the present invention comprises:
a cylinder 1, within which there is accommodated a piston 2 capable of sliding in a sealed manner in said cylinder, and which defines—jointly with said piston—a substantially sealed inner chamber 12,
a connecting or piston rod 3 connected at an end thereof to said piston 2 by means of a proper piston pin 4,
a main shaft 5 provided to include portions in the form of crank webs 6, on one of which there is applied—in a manner largely known as such in the art—the other end of the connecting rod 3,
a power generator provided with a rotor 7 and a related stator 8.

On the head 9 of said cylinder 1 there are provided two distinct through-bores 10, 11 (FIGS. 2 and 3), which enable said inner chamber 12 to communicate with the outside of the cylinder 1 via such means as they shall be described in greater detail further on.

The working fluid that may be used for said Rankine-cycle machine, and which fills up said inner chamber 12 to be then ejected therefrom, is a thermodynamic fluid of a kind as largely known as such in the art, and preferably is an organic fluid of the ORC (Organic Rankine Cycle) type.

Provided at a location corresponding to said cylinder head 9 there is a body 17 featuring a cylindrical cavity, in which there is accommodated a rotating valve 13, whose axis of rotation X is oriented in a direction orthogonal to the axis X of the cylinder 1.

Such rotating valve 13 is provided with two inner through-channels, i.e. a suction channel 14 and an exhaust channel 15.

Said suction channel 14 is shaped so that, when said valve 13 rotates into a given, pre-defined position, the suction port 14A thereof on the side facing the cylinder 1 comes exactly into a location in front of one of the afore-mentioned through-bores, namely the inlet one 10.

In that same position of the rotating valve 13, the opposite port 14B of the channel 14 comes to be located so as to directly flow—through a bore 18A—into a conduit 18 provided inside another body, which may in an advantageous manner be formed by an appropriate portion of said same body 17.

Said conduit 18 opens into the outside via a respective port 18B.

As a result, in said position of rotation of the rotating valve 13 (FIGS. 2 and 5), the inner chamber 12 of the cylinder 1 is enabled to communicate with the outside, so that a flow of gas from the outside is able to flow into said inner chamber 12 by passing through said port 18B, said conduit 18, said port 18A, said port 14B, said suction channel 14 and the port 14A thereof and said through-bore 10 in a sequence.

As far as the flowpath is concerned, which is followed by the gas when exiting from the interior of the chamber 12 and moving towards the outside, a similar scheme may of course be implemented.

The exhaust channel 15, through which the gas is exhausted from said inner chamber 12, is provided with a respective exhaust port 15A, which, at a given, precisely pre-defined position of rotation of said rotating valve 13, comes to be located exactly in front of said exhaust through-bore 11.

However, for reasons that shall be better explained further on, there is preferred that said exhaust channel 15 be provided with an opposite through-bore 15B that opens directly into the outside of the cylinder, without any need for it to therefore pass through said body 17, as represented in FIG. 3.

The geometrical configuration, the architecture and the size of the above-described component parts and details are such that, when at a first position of the rotating valve 13 said channel 14 establishes a communication between the outside and the inner chamber 12 (via the conduits 14 and 18), the same rotating valve also cuts off the exhaust flowpath from the inner chamber 12 towards the outside, owing to said rotating valve 13 closes off also the passage from said exhaust through-bore 11 to the exhaust channel 15 in the same valve (see FIG. 2).

And this is true also the other way round, of course, as this is exemplarily shown in FIG. 3.

On the other hand, the way in which rotating valves are used and operate in view of feeding or supplying the interior of a cylinder, in which a piston is sliding in a reciprocating manner, is largely known as such in the art, so that it shall not be explained herein to any further detail for reasons of brevity and greater simplicity.

There are furthermore provided drive means for rotatably driving the above-mentioned rotating valve, as this shall be described in greater detail further on, in such manner as to ensure that these means, as combined with the geometrical and dimensional configuration of the above-described members and elements, are adapted to cause—at each complete rotation of the main shaft 5—said port 14A to rotate by a short interval, comprised within that same complete rotation, in front of said through-bore 10, so as to enable the inner chamber 12 of the cylinder to be permanently communicating with the outside of said cylinder via said channel 14 and said conduit 18, and the respective ports at the ends thereof.

In a subsequent interval of the same rotation, said valve 13 shuts off the access to said inlet bore 10 and sets said inner chamber 12 in a state, in which it communicates with the outside of the cylinder.

In other words, said inner chamber 12 is switched into alternately communicating with the two inlet and exhaust conduits 14 and 15 according to a sequence that is synchronized with the displacement and the position of the piston 2, and such opening/closing sequence of the inlet through-bore 10, along with the similar opening/closing sequence of the other through-bore 11, are driven by the rotating main shaft 5 and are comprised within each single and same rotation thereof.

As a result, when a gas is admitted—at a suitable pressure and in the manner as this has been described hereinbefore—into said inner chamber 12, there occurs a reciprocating movement of said piston 2 within said cylinder 1; having provided the crank web portion 6 as described afore, the latter is effective in converting such reciprocating movement of the piston into a rotary motion of said same main shaft, which can therefore be used to drive an electric rotary motor of a general type comprised of a rotor 7, e.g. press-fitted onto said main shaft 5, and a stator 8, both of them largely known as such in the art.

This rotary electric motor then generates one or more electric voltages adapted to supply—via appropriate electric connections (not shown)—power-using devices that may be provided in a wide variety of kinds and forms to a wide variety of purposes, uses and applications.

Therefore, if the admitted gas is a thermodynamic fluid, preferably of an ORC kind as this is largely known as such in the art, flowing in from an evaporator means at a suitable pressure, owing to its having been heated up by a heat source of a general kind, what is obtained is a machine that uses the Rankine cycle in a particularly efficient manner.

As far as the recovery of the gas exhausted from the cylinder 1 via the through-bore 11 and the rotating valve is concerned, the related aspect shall be discussed in greater detail further on.

The advantage of the above-described arrangement lies in the fact that the rotating valve offers a number of real and remarkable advantages over the usual inlet and exhaust function based on the use of stem or needle valves, wherein such advantages may be summarized as follows:
a very high level of reliability,
no wear or tear of the parts involved in the process and, as a result, very limited maintenance requirements,
substantially no need for adjustments and further “calibrations”,
reduced energy input and usage, since a solely rotary motion is produced and used, actually;
in addition—and this is another substantial reason why a rotating valve is preferred in the application—it should be noticed that the solution based on the use of the traditional stem or needle valves, with the related tappets, camshaft, etc., is basically preferred when the gases to be transferred are very hot; in fact, the rotating valve is inherently vulnerable to such high temperatures, since the gas that unavoidably leaks out between the same valve and the related apertures in the head of the cylinder would come into contact with the lubricant used there, thereby wearing it out in a very short time.

On the contrary, in the Rankine cycle described above, when use is made of fluids heated to a low-to-medium temperature reaching up to 250° C. at the most, the above-noted drawback does not show up at all, so that there is no counter-indication left to the use of the rotating valve, which can therefore be applied without any risk at all, while taking the most out of the inherent advantages thereof.

Some advantageous improvements and modifications in the embodiment of the present invention can anyway be additionally introduced or implemented as a further improvement of the above-described solution, i.e.:

1) With reference to FIGS. 3, 4 and 5, it can be readily appreciated that it is necessary for the rotating valve 13 to be able to rotate in synchronism with the displacement motion of the piston, so that the suction or inlet through-bore 10 is practically able to always open when the piston is in a pre-established position thereof, typically when it reaches angles—of either advance or lag—relative to the top dead centre, which depend on the ratio of the operating pressures to each other, and is further able to be closed after a pre-defined fraction of time, before the piston reaches down to the bottom dead centre; a similar situation—albeit in an inverted sequence, of course—shall be ensured to occur also as far as the opening and closing of the exhaust through-bore 11 is concerned.

To this purpose, said main shaft is connected to said rotating valve 13 via an assembly 27 of kinematical members, including gears, pinions, idler gears, and the like, which are adapted to act upon the drive shaft 19 used to rotatably drive the rotating valve 13, wherein part of said assembly is preferably housed in said same body 17, so as to ensure that the above-noted conditions will anyway occur and apply.

Since the main shaft performs a complete rotation under a double both upward and downward stroke of the piston, all it takes is to provide said kinematical assembly and the related mechanisms so that to a revolution of the main shaft there will correspond a single revolution of the rotating valve that will cause both the inlet or suction flowpath via the through-bore 10 to open and close and then the exhaust flowpath via the through-bore 11 to open and close in turn.

Other solutions departing from the above-described one may of course be implemented, such as those based on the use of either a rotating valve having the axis of rotation thereof extending parallel to the axis X of the cylinder, or two distinct rotating valves; anyway, the selection of such valves and the synchronization thereof are fully within the ability of those skilled in the art, so that a detailed description thereof shall be omitted.

The solution based on the provision of a single rotating valve 13, whose axis of rotation Y extends orthogonally to the axis X of the cylinder, has therefore been given the preference, and has been described and illustrated accordingly, since it allows for easy motion transmission from the main shaft 5.

2) A second improvement is implemented as follows: with reference to FIGS. 1, 4 and 5, all parts and members described above, i.e. said cylinder 1, said rotating valve 13, said kinematical assembly 27, and said power generator 7, 8 are accommodated and enclosed in a suitable sealed casing 20, within which they are supported and secured with the aid of appropriate fastening means, such as brackets 21, bolts, and the like.

The reason behind the selection of such option is a three-fold one, as this will be indicated below.

In the first place, the circumstance that a rotating valve is being used unavoidably implies a slight loss of gas leaking into the environment outside of the same valve and the cylinder 1. For such loss of leaking gas to be recovered, a practical need therefore arises for the entire cylinder to be enclosed—jointly with all parts and assemblies connected therewith—within a casing, which shall of course have a sealed construction, and shall further include both gas suction or inlet provisions and gas exhaust provisions thereinside.

This solution can obviously be implemented and obtained in the desired manner by making use of the casing 20 described above.

As far as the selected option to have also the mechanical part of the whole assembly, i.e. the connecting rod 3, the main shaft 5, as well as the power generator with its stator and rotor, enclosed in said sealed casing 20 is then concerned, it can readily be appreciated to proceed as a practically forced, unavoidable choice, since any different solution would prove much more difficult and expensive to implement, considering the need for the above-cited parts and members installed outside of said casing 20 to be in this case duly insulated.

In the second place, it should be considered that if the gas being exhausted from the inner chamber 12 of the cylinder 1, due to the action of the piston stroke as it moves upwards in the direction of the head of the cylinder, would be directly conveyed into the outside environment, it would carry also those oil particles with it, which are always unavoidably included in the thermodynamic gas, and this would prevent the same oil from duly separating from the fluid, thereby ultimately impairing the properties of the same fluid in the long run.

In the third place, it should be further considered that the power generator, comprising the rotor 7 and the stator 8, tends to obviously heat up when operating, so that, for said generator to be safely prevented from over-heating to any excessive extent, it must be duly cooled.

In view of doing away with both above-noted drawbacks, the exhaust conduit 15 of the rotating valve 13 opens in an advantageous manner directly into the inner volume of the sealed casing 20, as this is symbolically represented in FIG. 2, instead of being directly connected with the outside of the casing via the body 17, as this on the contrary occurs in the case of the suction conduit 14 of the same valve 13.

Therefore, the exhaust through-bore 11 is not accompanied by any corresponding exhaust conduit conveying the gas discharged by the piston directly outside the casing 20; quite on the contrary, upon flowing through said exhaust port 11 and, of course, the related conduit 15 in the rotating valve 13, the gas flows immediately into the interior of the sealed casing 20, from which it flows then out in a regular manner through a proper outlet mouth 22 that opens into a proper gas return conduit.

The gas then expands within the inner volume of the sealed casing 20 and, as a result, a two-fold result can be achieved in that the oil in the gas is able to spontaneously drop onto the bottom of said casing and, therefore, separate from the gas, while the latter is furthermore able to effectively act as a cooling fluid for the power generator enclosed in the same sealed casing 20.

Finally, as a last, albeit not less significant reason to be cited in this connection, it should be stressed that said casing 20 constitutes an ideal means in view of having the entire inventive machine enclosed and contained therein, since its nature of hermetically sealed casing practically prevents it from having accessible mechanical or electrical parts, and since functional and operating machine parts can be arranged and positioned in a stable and definitive manner thereinside, without any risk for them to undergo undue tampering from outside.

As a result, a machine is provided, which—when viewed from outside—looks out exactly as a single hermetically sealed casing exposing solely the unavoidably required connection fittings to view, i.e. the two suction and exhaust ports for the thermodynamic gas and the electrical connections for the generated power to be output and sent to the using load.

Fully apparent should at this point be the fact that said inlet mouth (18B), as cited hereinbefore, is provided in the wall of said casing 20 so that the thermodynamic fluid is able to flow therethrough to reach into said inlet channel 14 in the rotating valve 13 and the related outlet or suction port 14A, and eventually—through said inlet through-bore 10, into the inner chamber 12 of the cylinder 1.

The operation of the inventive machine as it has been described above is as follows, although it may be assumed to have already been substantially figured out by the reader: with reference to FIG. 9, the hot reservoir 101 (which can in principle be a heat source of any kind) heats up a boiler 102, commonly referred to also as the evaporator, which contains the thermodynamic fluid used for the Rankine cycle. This fluid is then heated up until it is brought to evaporation, while at the same time increasing the pressure thereof, and flows through a delivery conduit 103, from which it is let into said sealed casing 20 through the afore-cited inlet mouth 18A thereof located in the wall of said sealed casing 20, and in particular through the conduit 18, the channel 14 in the rotating valve 13, said exhaust conduit 15 and said through-bore 10 into said inner chamber 12, in which it is able to expand owing to the higher pressure thereof.

Owing to such expansion effect, the piston 2 is urged to displace in a reciprocating manner as this is widely known as such in the art, thereby causing said main shaft 5 to rotate and, ultimately, driving said power generator.

The gas flow is then exhausted by the piston through said exhaust through-bore 11 to flow into the sealed casing 20, from which it eventually flows out through said outlet mouth 22.

From said outlet mouth, the same conduit 103, which now works as a return conduit, conveys the gas into an appropriate condenser 104, in which the gas is condensed, frequently by means of a so-called cold reservoir 106; then, by the action of a pump 105, it flows back into said boiler 102.

In an advantageous manner, said main rotating shaft 5 is directly press-fitted on to the rotor 7; as a result, the axis of rotation Z of said shaft 5 turns out as being substantially orthogonal to said axis X of the cylinder 1 and, therefore, it turns also out as being parallel to the axis of rotation Y of the rotating valve 13.

The described solution of a machine adapted to be used to power generation purposes may be advantageously applied and put to good account in a number of circumstances and environments that may also differ quite a lot from each other; with reference to FIG. 9A, the heat supply source C may be constituted by an industrial waste water or flue exhaust system, whereas the heat exchanger may use a cold source F, which may for instance be constituted by some watercourse, or—as this is shown in FIG. 9B—an ambient-air condenser, if conditions are such as to allow it. Similarly, FIGS. 9C and 9D illustrate similar situations, wherein the hot source is however constituted by a battery of solar panels P in this case.

Shown in these FIGS. 9A through to 9D there is also the provision, and the related connection in the circuit, of a storage reservoir 108 located between the condenser 104 and the pump 105; the role played by this storage reservoir is quite an important one in the thermodynamic circuit considered, since the liquid that has just been condensed in the condenser is at a temperature lying just slightly below the condensation temperature; therefore, if the pump 105 is a pump of a conventional type, or an impeller-type pump, the rotation of the blades would cause a negative pressure condition to be created on the suction side of the pump, under an abrupt drop in pressure, and might therefore cause the liquid to evaporate to thereby trigger the detrimental cavitation corrosion effect.

Exactly in view to prevent such situation from occurring, said storage or buffer reservoir 108 is introduced in the circuit as explained above on the ground that on the bottom of such reservoir there is then collected an amount of liquid, in which the conduit leading to the pump 105 is submerged for it to be able to ensure a continuous supply of liquid at an adequate pressure at the inlet of the pump 105.

The ultimate result is that the main shaft 5 is caused to rotate.

1-10. (canceled)

11. A closed Rankine cycle machine for conversion of thermal energy into electric energy, comprising:
an evaporator configured to heat thermodynamic fluid and to bring the thermodynamic fluid to evaporation while at the same time increasing a pressure thereof;
a delivery conduit configured to receive the thermodynamic fluid from the evaporator;
a cylinder that houses a sliding piston and that defines a variable volume chamber, the cylinder comprising a head with an inlet opening and an outlet opening, the delivery conduit leading to the cylinder;
a connecting-rod engaged to the sliding piston;
a main shaft engaged to the connecting-rod;
an electric generator including a rotor and a related stator, the electric generator being activated by the main shaft;
a return conduit configured to receive the thermodynamic fluid exhausted from the cylinder and to convey the thermodynamic fluid to a condenser and then back to the evaporator;
at least one valve configured to selectively allow communication between the delivery conduit and the variable volume chamber in the cylinder and between the variable volume chamber and the return conduit; and
at least one pump located on one of the delivery conduit or the return conduit and configured to flow the thermodynamic fluid back into the evaporator.

12. The closed Rankine cycle machine according to claim 11, wherein the at least one valve is a rotating valve provided with at least an inlet through-channel and an outlet through-channel, the rotating valve allowing the selective communication of the variable volume chamber, the rotating valve selectively connecting the inlet through-channel and the outlet through-channel with the delivery conduit and the return conduit, respectively.

13. The closed Rankine cycle machine according to claim 11, wherein the at least one valve is operated by a plurality of motion transmission members connected to and activated by the main shaft, the plurality of motion transmission members being configured such that a rotation of the at least one valve is synchronized to displacement motion of the sliding piston.

14. The closed Rankine cycle machine according to claim 11, further comprising a storage reservoir located between the condenser and the at least one pump, the storage reservoir having a bottom for collecting an amount of liquid in which the return conduit leading to the at least one pump is submerged, the storage reservoir ensuring a continuous supply of the liquid at an adequate pressure to an inlet of the at least one pump.

15. A closed cycle machine working according to the Rankine cycle for conversion of thermal energy into electric energy, comprising:
a cylinder that houses a piston and that defines a variable volume chamber, the piston being lodged and slideable within the cylinder;
a connecting-rod engaged to the piston and to which a main shaft is engaged;
an electric generator including a rotor and a related stator, the electric generator being activated by the main shaft,
wherein the cylinder defines a head including an inlet opening and an outlet opening through which a thermodynamic fluid is fed, and
wherein at least one rotating valve is provided including at least an inlet through-channel capable of allowing selectively controllable communication through the inlet opening arranged between an inlet conduit and the variable volume chamber of the cylinder and an outlet through-channel capable of allowing flow of the thermodynamic fluid from the variable volume chamber to an outside of the cylinder through the outlet opening.

16. The closed cycle machine according to claim 15, wherein the at least one valve is synchronized to displacement motion of the piston and is operated by a plurality of motion transmission members, the plurality of motion transmission members being connected to and activated by the main shaft.

17. The closed cycle machine according to claim 15, further comprising:
an evaporator containing the thermodynamic fluid used for a Rankine cycle and being configured to heat the thermodynamic fluid until the thermodynamic fluid is brought to evaporation while at the same time increasing a pressure thereof;
a delivery conduit that conveys the thermodynamic fluid into the inlet conduit, the inlet through-channel of the at least one valve and via the inlet opening into the variable volume chamber, the delivery conduit configured to allow the thermodynamic fluid to expand;
a return conduit that conveys the thermodynamic fluid into a condenser in which the thermodynamic fluid is condensed; and
a pump that flows the thermodynamic fluid back into the evaporator.

18. The closed cycle machine according to claim 17, further comprising a storage reservoir located between the condenser and the pump, the storage reservoir having a bottom for collecting an amount of liquid in which the return conduit leading to the pump is submerged, the storage reservoir ensuring a continuous supply of the liquid at an adequate pressure to an inlet of the pump.

19. The closed cycle machine according to claim 15, wherein the at least one valve rotates around an axis that is substantially orthogonal to an axis of the cylinder.

20. The closed cycle machine according to claim 15, wherein a body is arranged on the head of the cylinder, the body being provided with an inner cavity configured to house the at least one valve, and the body being configured to place the inlet through-channel in communication with the inlet opening at a predefined rotational position of the at least one valve.

21. The closed cycle machine according to claim 20, wherein the body is configured to place the outlet through-channel in communication with the outlet opening through an inside of the at least one valve such that the outlet through-channel opens to an outside of the cylinder without passing through the body.

22. The closed cycle machine according to claim 16, wherein the cylinder, the main shaft, the plurality of motion transmission members, the electric generator and the at least one valve are entirely contained inside a sealed container.

23. The closed cycle machine according to claim 22, wherein the body closes a portion of an outer surface of the sealed container, and wherein the body is provided with an inlet mouth entering into a conduit that guides the thermodynamic fluid into the inlet through-channel at a pre-defined rotational position of the at least one valve.

24. The closed cycle machine according to claim 23, wherein the sealed container is provided with an outlet mouth that communicates with an inside of the sealed container to an outside of the sealed container.

25. The closed cycle machine according to claim 15, wherein a rotation axis of the rotor is substantially parallel to a rotation axis of the at least one valve, and the rotation axis of the at least one valve is substantially orthogonal to an axis of the cylinder.

26. A process for conversion of thermal energy into electric energy, the process comprising:
providing a closed cycle machine including:
an evaporator configured to heat thermodynamic fluid and to bring the thermodynamic fluid to evaporation while at the same time increasing a pressure thereof;
a delivery conduit configured to receive the thermodynamic fluid from the evaporator;
a cylinder that houses a sliding piston and that defines a variable volume chamber, the cylinder comprising a head with an inlet opening and an outlet opening, the delivery conduit leading to the cylinder;
a connecting-rod engaged to the sliding piston;
a main shaft engaged to the connecting-rod;
an electric generator including a rotor and a related stator, the electric generator being activated by the main shaft;
a return conduit configured to receive the thermodynamic fluid exhausted from the cylinder and to convey the thermodynamic fluid to a condenser and then back to the evaporator;
at least one valve configured to selectively allow communication between the delivery conduit and the variable volume chamber in the cylinder and between the variable volume chamber and the return conduit; and
at least one pump located on one of the delivery conduit or the return conduit and configured to flow the thermodynamic fluid back into the evaporator;
heating up the evaporator until the thermodynamic fluid is brought to evaporation, while at the same time increasing the pressure thereof;
flowing the heated thermodynamic fluid through the delivery conduit into the variable volume chamber, in which the thermodynamic fluid is able to expand owing to the higher pressure the thermodynamic fluid, and urge the sliding piston to displace in a reciprocating manner thereby causing the main shaft to rotate and drive the electric generator;
exhausting gas from the variable volume chamber upon action of the sliding piston and flowing the gas into the return conduit;
conveying the gas into the condenser in which the gas is condensed; and
flowing the condensed fluid back into the evaporator.

27. The process according to claim 26, further comprising conveying the condensed fluid into a storage reservoir located between the condenser and the at least one pump on the return conduit, the storage reservoir having a bottom for collecting an amount of liquid in which the return conduit leading to the at least one pump is submerged, the storage reservoir ensuring a continuous supply of liquid at an adequate pressure at an inlet of the at least one pump.

28. The process according to claim 26, wherein the thermodynamic fluid is heated to a temperature not to exceed 250° C.
